(19) United States
(12) Patent Application Publication
(10) Pub. No.: US 2006/0100088 A1
(43) Pub. Date: May 11, 2006

(54) Transparent multi-cation ceramic and method of making

(75) Inventors: Sergio Paulo Martins Loureiro, Saratoga Springs, NY (US); Stanley John Stoklosa, Clifton Park, NY (US); James Scott Vartuli, Rexford, NY (US); James Anthony Brewer, Scotia, NY (US); Thomas Francis McNulty, Ballston Lake, NY (US); Venkat Subramaniam Venkataramani, Clifton Park, NY (US); Mohan Manoharan, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/984,593

(22) Filed: Nov. 9, 2004

(51) Int. Cl. C04B 35/505

(52) U.S. Cl. 501/152; 252/301.4 R; 264/621; 264/651; 264/645; 264/661; 264/604

(57) ABSTRACT

A method of making a multi-cation ceramic having an average grain size of less than 1 micron is provided. The method includes the steps of providing at least a first material and a second material, wherein the first material comprises a first cation and the second material comprises a second cation, and wherein the first cation and the second cation are different from each other and each of the first material and the second material are nanopowders; forming a mixture comprising the first material and the second material; forming a green body from the mixture; and forming a dense multi-cation ceramic material comprising the first cation and the second cation, wherein the dense multi-cation ceramic material comprises a major phase comprising the first cation and the second cation and that is different from the first material and the second material. The multi-cation ceramic has a high density and high in-line transmission.

### BACKGROUND OF THE INVENTION

The invention relates to a method of making a multi-cation ceramic. The invention also relates to a method of making a transparent multi-cation ceramic. More particularly, the invention relates to a method of making a transparent and grain-size engineered multi-cation ceramic through the use of nanopowders and their enhanced sintering ability.

Multi-cation ceramics—specifically transparent multi-cation ceramics—are widely used in lighting, medical, industrial, homeland security, and defense applications. For example, transparent ceramic scintillators, such as yttrium aluminium garnet (YAG) with dopants find applications in imaging, non-destructive evaluation, and sensors. Alumina, yttria, YAG, Aluminum oxynitride, and magnesium aluminate spinel are good candidates for lighting, automotive, and harsh environment windows. Consequently, efforts have been directed towards producing transparent ceramics of these and other materials. For many of these applications it is desirable to have high strength and machinablity.

Transparent ceramics are typically made by pressure sintering micron and sub-micron size powders. Generally, micron-size ceramic powders of the desired phase are synthesized by solid-state routes, compacted, and sintered to form transparent ceramic articles. It is difficult to limit or control the grain size during high pressure sintering processes. Alternatively, synthesis of ceramic nanopowders may be achieved by wet chemical routes, followed by compaction and sintering. In both of these two step-processing methods, controlling grain growth is difficult, and only limited success in obtaining dense, fine-grained ceramics has been achieved.

In single step-processes, it is difficult to achieve both phase formation and sintering while limiting grain growth during processing, due to the inherent problems associated with nanopowders. One such problem is the strong agglomeration of the nanocrystallites within the nanoparticles. Another problem is the tendency of nanopowders to resist compaction due to electrostatic repulsion between nanoparticles. These effects lead to loose packing of particles, low density, and high levels of porosity in a green body. In a single step process, achieving dense compaction is even more challenging, as a suitable combination of surfactants to enable simultaneous surface modification of different reactants may be needed to achieve uniform and homogeneous packing of the green body. Another challenge is controlling rapid grain growth associated with the enhanced reactivity of nano materials. Generally, grain growth inhibitors are used to overcome this problem, but they may have adverse effects on the optical and mechanical properties of the final product. In addition, pores tend to be trapped within the nanoparticles during sintering, yielding ceramic bodies with high scattering coefficients and poor mechanical properties.

The approaches in the prior art to these problems have produced only limited success. Therefore, what is needed is a versatile and simple processing technique to fabricate transparent and grain-size engineered ceramics.

### SUMMARY OF THE INVENTION

The present invention meets these and other needs by providing a transparent multi-cation ceramic material and a method for making a multi-cation ceramic material in a single step process.

Accordingly, one aspect of the invention is to provide a method of making a multi-cation ceramic material. The method comprises the steps of: providing at least a first material and a second material, wherein the first material comprises a first cation and the second material comprises a second cation, and wherein the first cation and the second cation are different from each other and each of the first material and the second material are nanopowders; forming a mixture comprising the first material and the second material; forming a green body from the mixture; and forming a dense multi-cation ceramic material comprising the first cation and the second cation, wherein the dense multi-cation ceramic material comprises a major phase that is different from the first material and the second material and has an average grain size of less than 1 micron.

A second aspect of the invention is to provide a method of making an article comprising a multi-cation ceramic material. The method comprises the steps of: providing at least a first material and a second material, wherein the first material comprises a first cation and the second material comprises a second cation, wherein the first cation and the second cation are different from each other and each of the first material and the second material are nanopowders; forming a slurry comprising the first material, the second material, at least one dispersant, and a solvent; mixing the slurry to form a mixture comprising the first material and the second material; drying the slurry to form a powder; forming a green body from the powder; sintering the green body at a controlled pressure to form a sintered body; and finishing the sintered body to form the article, wherein the article comprises a major phase comprising the first cation and the second cation, and wherein the major phase is different from the first material and the second material and has an average grain size of less than 1 micron.

A third aspect of the invention is to provide a method of making an article comprising a multi-cation ceramic material. The method comprises the steps of: providing at least a first material and a second material, wherein the first material comprises a first cation and the second material comprises a second cation, wherein the first cation and the second cation are different from each other and each of the first material and the second material are nanopowders; forming a slurry comprising the first material, the second material, at least one dispersant, and a solvent; mixing the slurry to form a mixture comprising the first material and the second material; drying the slurry to form a powder; forming a green body from the powder; sintering the green body at a controlled pressure to form a sintered body; and finishing the sintered body to form the article, wherein the article comprises a major phase comprising the first cation and the second cation, wherein the major phase is different from the first material and the second material and has an average grain size of less than 1 micron and is transparent, and wherein the article has a specular transmission of at least 50% normalized to a 1 mm thick specimen. A fourth aspect of the invention is to provide a ceramic material. The ceramic material comprises a major phase. The major phase comprises at least a first cation and a second cation, wherein the first cation and the second cation are different from each other, and has an average grain size of less than 1 micron. The ceramic material is transparent and has a specular transmission of at least 50% normalized to a 1 mm thick specimen. Yet another aspect of the invention is to provide a ceramic article. The ceramic article comprises a major phase. The major phase comprises at least a first cation and a second cation, wherein the first cation and the second cation are different from each other, and has an average grain size of less than 1 micron, wherein the ceramic article is formed by a method including the following steps: providing at least a first material and a second material, wherein the first material comprises a first cation and the second material comprises a second cation, wherein the first cation and the second cation are different form each other and wherein each of the first material and the second material are nanopowders; forming a slurry comprising the first material, the second material, at least one dispersant, and a solvent; mixing the slurry to form a mixture comprising the first material and the second material; drying the slurry to form a powder; forming a green body from the powder; sintering the green body at controlled pressure to form a sintered body; and finishing the sintered body to form the ceramic article.

These and other aspects, advantages, and salient features of the present invention will become apparent from the following detailed description, the accompanying drawings, and the appended claims.

### BRIEF DESCRIPTION OF FIGURES

FIG. 1 is a flow diagram for preparing a multi-cation ceramic according to one embodiment of the present invention;

FIG. 2 is a scanning electron micrograph of a multi-cation YAG:Nd, Mg ceramic made in accordance with the process described in FIG. 1;

FIG. 3 is a photograph of a transparent YAG ceramic made in accordance with the process described in FIG. 1;

FIG. 4 is a graph illustrating the in-line and total transmission vs. wavelength of a multi-cation YAG ceramic made in accordance with the process described in FIG. 1; and

FIG. 5 is flow diagram for preparing an article comprising a multi-cation ceramic according to one embodiment of the present invention.

### DESCRIPTION OF THE INVENTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

In the following discussion, for simplicity Y₃Al₁₅O₁₂ is denoted as YAG, YAG with neodymium doping is denoted as YAG:Nd, YAG with ytterbium doping is denoted as YAG:Yb, and YAG with neodymium doping and magnesium additive is denoted as YAG:Nd, Mg. For the purposes of understanding the invention, a nanopowder is understood to be a powder in which the primary crystallite size is less than 500 nm and the average particle size is below 1 micron. In one embodiment, the primary crystallite size is less than 100 nm and, in another embodiment, the primary crystallite size is less than 60 nm. In one embodiment, the average particle size is less than 500 nm, and, in another embodiment, less than 100 nm.

There is a large demand for transparent materials across a range of technological and industrial applications. Traditionally, single crystals are used for this purpose. Transparent polycrystalline ceramics are highly desirable for these applications because, when compared to single crystals, they allow the use of lower concentrations of dopants, higher concentrations and uniformity of optical activators, and have lower processing temperatures. In addition, polycrystalline ceramics allow near-net or net shape fabrication and molding of articles. This cannot be achieved using single crystals. However, preparing polycrystalline ceramics having high transparency is a challenging task, as polycrystalline ceramics have a large number of scattering centers, such as pores, possible multiple second phases, and defects at grain boundaries. A high degree of transparency can be achieved either in a high-density ceramic having an extremely low residual porosity, or in a ceramic where the length scale of at least one of the porosity and any second phases present are below the scattering regime considered. In recent years, efforts to synthesize high density, transparent ceramics of high transparency and to develop versatile methods for making transparent ceramics have been made. Hot pressing techniques have been used to obtain transparent ceramics. However, the operations involved in producing transparent ceramic articles using such a method are very complex and potentially costly.

Pressureless sintering can be used to make transparent ceramics by considerably increasing the specific surface area and decreasing the particle size of the starting reactant particles. Even though this method may provide transparency, it tends to yield ceramic bodies having large grain sizes, which adversely affect mechanical strength. Despite such efforts, there is no method to easily produce high-density transparent ceramics having engineered fine grain sizes on an industrial scale. Disclosed herein is a versatile method for making transparent, high-density multi-cation ceramics with controlled grain size.

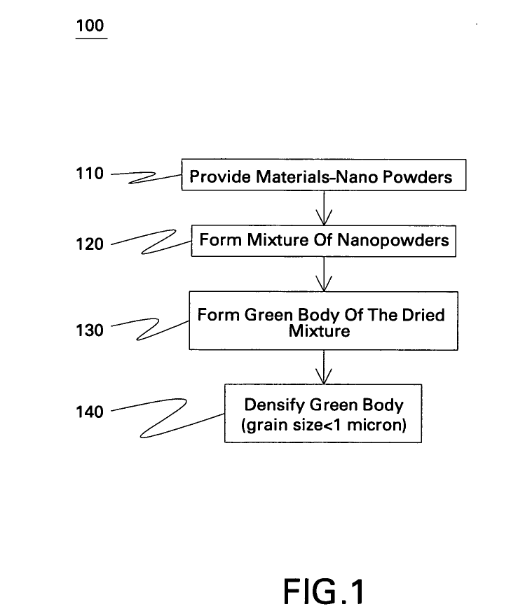

Referring to the drawings in general and to FIG. 1 in particular, it will be understood that the illustrations are for the purpose of describing one embodiment of the invention and are not intended to limit the invention thereto.

One aspect of the present invention is to provide a method of making an article comprising a multi-cation ceramic material. The method of making a multi-cationic ceramic is shown as a flow diagram in FIG. 1. The method of making a multi-cation ceramic of the present invention is a single step formation and sintering process based on the enhanced sintering ability of nanopowders. Being a single step pressureless sintering process, it eliminates cumbersome apparatus and multiple steps involved in the general processes used for preparing transparent multi-cation ceramics. Unlike previously known methods, method 100 described herein provides a method to confine the grain sizes of the multi-cation ceramic to less than a micron.

The method 100 summarized in FIG. 1 begins with step 110, in which at least a first material and a second material are provided. The first material comprises a first cation and the second material comprises a second cation that is different from the first cation. Each of the first material and the second material are nanopowders. Additional materials comprising cations other than the first cation and second cation may also be provided as nanopowders. It is understood that, whenever such additional materials and cations are provided, any subsequent steps described herein involving the first material and second material also include any such additional material. In one embodiment, the first and second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron. Non-limiting examples of the first material and the second material include, but are not limited to, solid inorganic oxides, fluorides, nitrides, carbides, and chalcogenides. In one embodiment, the first material is an oxide of a lanthanum group metal. In another embodiment, the first material and the second material are nanopowders having a primary particle size below 1 micron, preferably below 500 nm, and more preferably below 100 nm. Nanopowders are preferred due to their enhanced sintering ability, which enables higher density to be achieved at reduced processing temperatures.

In step 120, a mixture comprising the first material and the second material is formed. The step of forming a mixture comprising the first material and the second material may comprise either wet mixing or dry mixing. Wet mixing comprises forming a slurry comprising the first material, the second material, and a solvent. Either aqueous or nonaqueous solvents may be used. Nonaqueous solvents may be either polar or nonpolar solvents. In one embodiment, the polar solvent is an alcohol. Nonpolar solvents such as alkanes and alkenes may also be used. Non-limiting examples of nonpolar solvents include hexane, toluene, carbon tetrachloride and the like. Liquids having low surface tension are preferred solvents, as high surface tension promotes agglomeration. Strong agglomerates lead to poor packing of the particles in the green body, which in turn produces low density and porosity in the in the final sintered body.

In another embodiment, the step of forming a slurry comprises adding a dispersant to the slurry. The dispersant effectively disperses the reactant powders in the slurry and has no significant deleterious effect on the sintered product. Non-limiting examples of dispersants include, but are not limited to, sodium polyacrylates, ammonium polyacrylates, ammonium polymethacrylates, polyvinyl alcohols, alkyl stearates, organo-phosphates, alkyl ammonium bromide salts, block copolymers, combinations thereof, and the like. Generally, from about 1.0 to 10.0 pph (parts per hundred parts solvent) of dispersants are provided.

If dry mixing is involved, any of the dry mixing methods known in the art such as fluid energy mixing, vibratory mixing, static mixing, jet milling, ball milling and the like may be used. Alumina, zirconia, yttria stabilized zirconia, agate, nylon, silicon nitride, or Teflon® may serve as the milling media.

If wet mixing is used, the mixture is dried to form a dried mixture. Non-limiting examples of drying methods that may be used include, but are not limited to, temperature-assisted drying, spray drying, freeze drying, and reduced pressure drying of the mixture. The drying method is chosen so as to produce a dried mixture. In step 130, a green body is formed from the dried mixture. A number of techniques can be used to form the green body, such as, but not limited to, compacting under uniaxial pressure, biaxial pressure or isostatic pressure. Net-shape or near net-shape fabrication by techniques such as extrusion, injection molding, slip casting, and gel casting may also be used. In one embodiment, the green body has a density of at least about 40% of the theoretical density of the major phase of the multi-cation ceramic material and, in another embodiment, at least about 50% of the theoretical density to promote further densification during sintering and achieve the desired optical transmission.

In step 140, a dense ceramic body is prepared by densifying the green body. In one embodiment, the green body is sintered in a controlled -atmosphere and under a controlled pressure. In another embodiment, the green body is pre-fired in an oxygen-containing atmosphere at a temperature below about 1000° C. Pre-firing is generally carried out at a temperature in a range from about 500° C. to about 1000° C. to burn off organic binders and surfactants. The pre-firing temperature and time cycle that are actually used depend on the level of organic impurities present and the thickness of the ceramic samples. Following the pre-sintering step, the sintering process is carried out. Sintering may be conducted in or under reduced pressure (vacuum), ambient air, inert gas, reducing gas, oxidizing gas, or mixtures of such gases. Non-limiting examples of inert gases include, but are not limited to, argon and helium. Reducing gases include but are not limited to, dry or wet H₂, N₂, and CO/CO₂ mixtures. Oxidizing gases include, but are not limited to, O₂ and O₃. Generally, sintering is conducted at a temperature in a range from about 1000° C. to about 2100° C. for a time ranging from 0.5 h to 24 h. The rate of heating to the sintering temperature may vary and should have no significant deleterious effect on the green body. Generally, heating rates are in a range from about 1° C./min to about 10° C./min. The controlled pressure used for sintering is in a range from about 10⁻⁸ torr to about 1.6×10⁶ torr. Sintering in an ambient atmosphere with high diffusivity in the ceramic matrix is preferred to achieve high density. Sintering conditions are chosen to achieve a desired density and grain size, and depend on the particular materials system and thickness of the samples. Sintering conditions are also chosen to achieve complete pore filling, densification to a desired density value, and to confine the final grain size.

Sintering is optimized to enable simultaneous formation and sintering of the multi-cation ceramic with an average grain size of less than 1 micron. This is possible due to the enhanced sintering ability of the reactant nanopowders. The method of the present invention provides engineering of grain sizes and also provides means to limit the grain sizes to less than 1 micron in the final dense body.

Typically, the sintered body comprises the product multi-cation major phase, which is different form the constituent reactants, as determined by x-ray diffraction and electron microscopy measurements. In one embodiment, the major phase is one of an oxide, a boride, a carbide, a nitride an oxynitride, and combinations thereof. In one particular embodiment, the major phase is one of YAG, YAG:Nd, YAG, YAG:Yb and YbAG. In one embodiment, the sintered body has a density in a range from about 95% to 100% of the theoretical density of the major phase of the multi-cation ceramic material. In a second embodiment the sintered body has a density in a range from about 98% to 100% of the theoretical density and, in a third embodiment the sintered body has a density in a range from about 99% to 100% of the theoretical density. The sintered body generally has a grain size in a range from about 100 nm to about 3 microns. In one embodiment, the sintered body has an average grain size in a range from about 100 nm to about 2 microns, and, in another embodiment, in a range from about 100 nm to about 1 micron.

The processing of nanopowders presents many challenges, such as deagglomeration of powders, achieving high packing density in the green compact with controlled pore size and structure, and controlling grain size to achieve fine-grained ceramics having high mechanical strength. Because of their increased surface energy, primary nanocrystallites have a strong tendency to agglomerate into larger nanoparticles. These nanoparticles offer resistance to compaction due to increased electrostatic repulsion. The methods of the present invention successfully provide solutions to these problems and provide means of achieving high-density multi-cation of fine grain sizes.

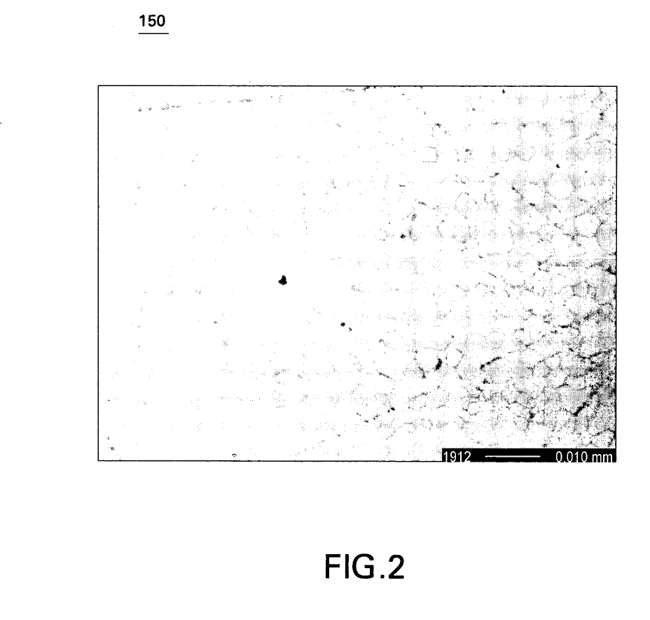

Turning to FIG. 2, a multi-cation ceramic prepared by the method of the present invention is shown. FIG. 2 is a scanning electron micrograph 150 of a YAG:Nd Mg multi-cation ceramic made in accordance with the process described in FIG. 1. The YAG:Nd Mg ceramic 160 comprises a plurality of grains. The plurality of grains in ceramic 160 has an average grain size in a range from about 1 micron to about 3 microns.

In one embodiment, the multi-cation ceramic is transparent. In one particular embodiment, the multi-cation ceramic is transparent to infrared radiation. In another embodiment, the multi-cation ceramic is transparent to ultraviolet radiation. In yet another embodiment, the multi-cation ceramic is transparent to visible light; i.e., in the optical wavelengths between about 400 nm and about 800 nm.

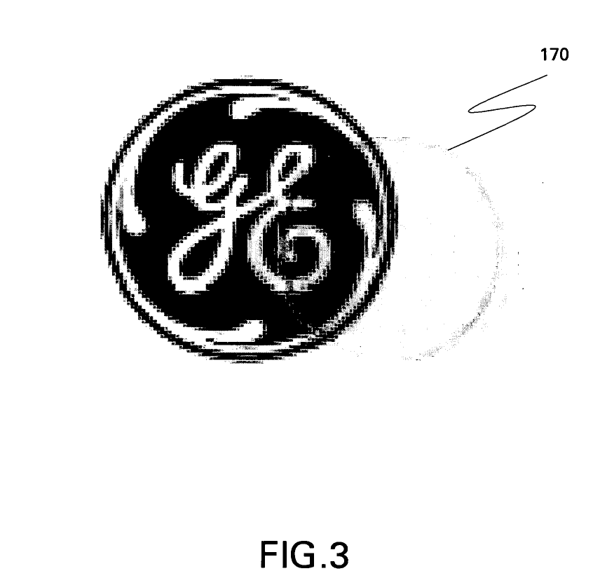

FIG. 3 shows a photograph of a transparent YAG ceramic wafer 170 having a thickness of about 2 mm, made in accordance with the process described in FIG. 1. The Figure clearly confirms the high degree of transparency of the ceramic prepared by the method of the present invention.

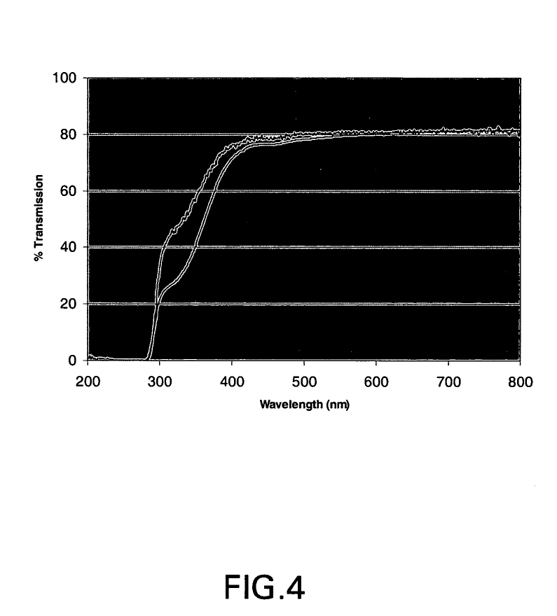

Referring to FIG. 4, the in-line and total transmission of light of a polished YAG ceramic wafer 170 having a thickness of about 2 mm and made in accordance with the process described above in FIG. 1 is measured at various wavelengths. FIG. 4 indicates that YAG ceramic prepared by the method of the present invention displays excellent transmission over a wide wavelength region. It shows both specular in-line and total transmissions of greater than 50%. In one embodiment, the multi-cation ceramic has a scattering coefficient of less than 0.05 mm⁻¹ and an absorption coefficient of less than 0.002 mm⁻¹. In another embodiment, the multi-cation ceramic has a specular transmission of greater than 65%.

The term ‘in-line transmission’ as used herein is understood to mean the ratio of the intensity of transmitted light to the intensity of incident light, obtained when a parallel beam of light of a certain intensity is incident perpendicular to the surface of a sample of given thickness. In the present embodiment, the in-line spectral transmission is determined on a polished plate of sintered body having a thickness of 1 mm at a wavelength of 554 nm.

The present invention makes it possible to fabricate simple, hollow, or complex-shaped multi-cation ceramic articles directly. Specifically, the sintered product can be produced in the form of useful ceramic articles such as plates, thin-walled tubes, long rods, spherical bodies, hollow shaped articles, and the like without significant or substantial machining.

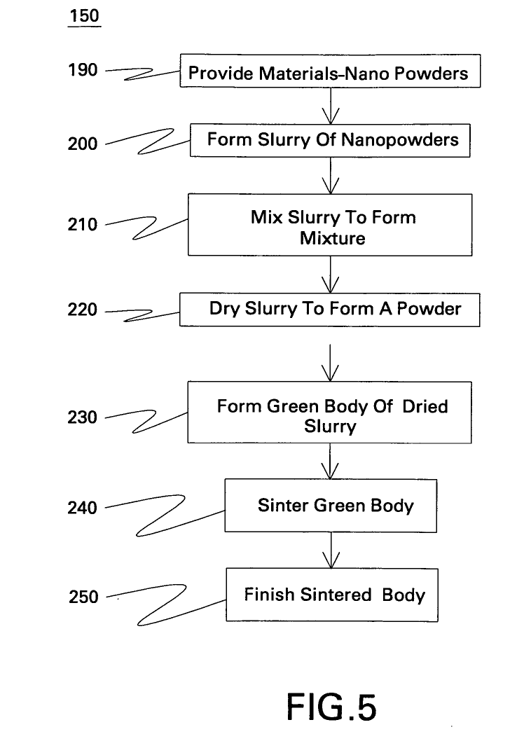

In a particular embodiment, method 180, shown as a flow chart in FIG. 5 provides a method to fabricate articles comprising a multi-cation ceramic. Method 180 begins with step 190, which includes providing at least a first material and a second material, wherein the first material comprises a first cation and the second material comprises a second cation that is different from the first cation, and wherein each of the first material and the second material are nanopowders. Additional materials comprising cations other than the first cation and second cation may also be provided as nanopowders. It is understood that, whenever such additional materials and cations are provided, any subsequent steps described herein involving the first material and second material also include any such additional material. Candidate materials and cations have been previously described hereinabove. In step 200, a slurry comprising the first material, the second material, at least one dispersant, and a solvent is formed. In step 210, the slurry is mixed to form a mixture comprising the first material and the second material. Step 220 includes drying the slurry to form a powder. In step 230, a green body of the desired shape is formed from the powder. In step 240, the green body is sintered at a controlled pressure to form a sintered body comprising a major phase, as previously described herein, and in step 250, the sintered body is finished to form the article of the desired shape.

The multi-cation ceramic described herein may have a wide variety of uses. For example, it may be useful in any system where a ceramic protective material or a plate having the present light-transmitting properties is needed. Specifically, it may be useful as a light-transmitting filter; a light emitting scintillator, when exposed to high-energy radiation, for medical imaging; industrial and non-destructive evaluation; passive and active screening of baggage and containers; light transmitting windows; lamp envelopes; etch-resistant windows for industrial applications; high-temperature, high-strength composites; and damage tolerant composites for transparent armor.

The following example serves to illustrate the features and advantages offered by the present invention, and not intended to limit the invention thereto.

### EXAMPLE 1

The following example describes the preparation method for transparent YAG Material, Y₃Al₅O₁₂. Stoichiometric amounts of Y₂O₃ and Al₂O₃, corrected to account for ignition losses at high temperatures, were mixed with Tetraethylorthosilicate, deionized water, and dispersants ammonium polyacrylate, ammonium polymethacrylate, styrene, and acrylic copolymers alumina (Al₂O₃) spheres served as the grinding media. The material was shaken and then placed on a ball mill for 15 hr to form a suspension. The suspension was defoamed with 3 drops of octanol, and separated from the media by pouring through a sieve cap. The media was rinsed with additional deionized water and stirred with a magnetic stirrer, and the suspension was then spray dried at an inlet temperature of about 200° C. The dried material was collected from the cyclone collector and the spray chamber. The resulting powder was pressed into pellets using a die in a hydraulic press. The pellets were then placed in a watertight latex sleeve and cold isostatic pressed at 40 kpsi pressure to obtain pieces that were about 50% dense. The pieces were then heated in a box furnace under flowing O₂ to burn off the organic binders and surfactants. The pre-sintering firing occurred at 900° C. with three intermediate steps. The pieces were cooled at 200° C./hr and then sintered at 1750° C. under vacuum to obtain near 100% dense pieces.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of making a multi-cation ceramic material, the method comprising the steps of:
a) providing at least a first material and a second material, wherein said first material comprises a first cation and said second material comprises a second cation, said first cation and said second cation being different from each other, and wherein each of said first material and said second material are nanopowders;
b) forming a mixture comprising said first material and said second material;
c) forming a green body from said mixture; and
d) forming a dense multi-cation ceramic material comprising said first cation and said second cation, wherein said dense multi-cation ceramic material comprises a major phase that is different from said first material and said second material and has an average grain size of less than 1 micron.

2. The method according to claim 1, wherein said dense multi-cation ceramic material is transparent.

3. The method according to claim 1, wherein said dense multi-cation ceramic material is transparent to infrared radiation.

4. The method according to claim 1, wherein said dense multi-cation ceramic material is transparent to ultraviolet radiation.

5. The method according to claim 1, wherein said dense multi-cation ceramic material is transparent to visible light.

6. The method according to claim 1, wherein a 1 mm thick specimen of said dense multi-cation ceramic material has a specular transmission of at least 50%.

7. The method according to claim 1, wherein said 1 mm thick specimen of said dense multi-cation ceramic material has a specular transmission of at least 65%.

8. The method according to claim 1, wherein each of said first material and said second material is one of a fluoride, an oxide, a nitride, a carbide, a chalcogenide, and combinations thereof.

9. The method according to claim 8, wherein at least one of said first material and said second material is an oxide of a lanthanum group metal.

10. The method according to claim 1, wherein said first cation and said second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron.

11. The method according to claim 1, wherein said major phase of said ceramic material is one of an oxide, a boride, a carbide, a nitride, an oxynitride, and combinations thereof.

12. The method according to claim 1, wherein said major phase of said ceramic material is one of YAG, YAG:Nd, YAG, YAG:Yb and YbAG.

13. The method according to claim 1, wherein said major phase of said ceramic material has a density in a range from about 98 percent to 100 percent of a theoretical density of said major phase.

14. The method according to claim 1, wherein, the step of forming a mixture comprising said first material and said second material comprises forming a slurry comprising said first material, said second material, and a solvent.

15. The method according to claim 14, wherein, said solvent is an aqueous solvent.

16. The method according to claim 14, wherein, said solvent is a nonaqueous solvent.

17. The method according to claim 16, wherein said nonaqueous solvent is a polar solvent.

18. The method according to claim 17, wherein said polar solvent is an alcohol.

19. The method according to claim 16, wherein said nonaqueous solvent is a nonpolar solvent.

20. The method according to claim 19, wherein said nonpolar solvent is one of an alkane, an alkene, and combinations thereof.

21. The method according to claim 19, wherein said nonpolar solvent is one of hexane, toluene, carbon tetrachloride, and combinations thereof.

22. The method according to claim 14, wherein, forming said slurry further includes adding a dispersant to said slurry.

23. The method according to claim 22, wherein said dispersant is one of a sodium polyacrylate, ammonium polyacrylate, an ammonium polymethacrylate, a polyvinyl alcohol, an alkyl stearate, an organo-phosphate, an alkylammonium bromide salt, block copolymers, and combinations thereof.

24. The method according to claim 1, wherein the step of forming a mixture comprising said first material and said second material comprises dry mixing of said first material and said second material.

25. The method according to claim 24, wherein the step of dry mixing comprises at least one of fluid energy mixing, vibratory mixing, static mixing, jet milling, ball milling, and combinations thereof.

26. The method according to claim 1, further comprising the step of drying said mixture to form a dried mixture.

27. The method according to claim 26, wherein the step of drying said mixture to form a dried mixture comprises at least one of temperature-assisted drying said mixture, spray drying said mixture, freeze drying said mixture, reduced pressure drying said mixture, and combinations thereof.

28. The method according to claim 1, wherein the step of forming a green body from said mixture comprises one of compacting said mixture under uniaxial pressure, compacting said mixture under biaxial pressure, compacting said mixture under isostatic pressure, extruding said mixture, injection molding said mixture, slip casting said mixture, and gel casting said mixture.

29. The method according to claim 1, wherein the step of forming said dense multi-cation ceramic material comprises sintering said green body.

30. The method according to claim 29, wherein the step of sintering said green body comprises sintering said green body in a controlled atmosphere.

31. The method according to claim 30, wherein said controlled atmosphere comprises at least one of ambient air, an inert gas, a reducing gas, an oxidizing gas, and combinations thereof.

32. The method according to claim 31, wherein the step of sintering said green body comprises sintering said green body under a controlled pressure.

33. The method according to claim 32, wherein said controlled pressure is in a range from about 10⁻⁸ torr to about 1.6×10⁶ torr.

34. The method according to claim 29, wherein the step of sintering said green body comprises sintering said green body at a temperature in a range from about 1000° C. to about 2100° C. for a predetermined time.

35. The method according to claim 34, wherein said predetermined time is in a range from about 0.5 hour to about 24 hours.

36. The method according to claim 1, wherein the step of providing at least a first material and a second material further comprises providing at least one additional material, wherein said at least one additional material comprises at least one cation that is different from said first cation and said second cation, and wherein said at least one additional material is a nanopowder.

37. A method of making an article comprising a multi-cation ceramic material, the method comprising the steps of:
a) providing at least a first material and a second material, wherein said first material comprises a first cation and said second material comprises a second cation, said first cation and said second cation being different from each other, and wherein each of said first material and said second material are nanopowders;
b) forming a slurry comprising said first material, said second material, at least one dispersant, and a solvent;
c) mixing said slurry to form a mixture comprising said first material and said second material;
d) drying said slurry to form a powder;
e) forming a green body from said powder;
f) sintering said green body at a controlled pressure to form a sintered body; and
g) finishing said sintered body to form said article, wherein said article comprises a major phase comprising said first cation and said second cation, wherein said major phase is different from said first material and said second material and has an average grain size of less than 1 micron.

38. The method according to claim 37, wherein each of said first material and said second material is one of a fluoride, an oxide, a nitride, a carbide, a chalcogenide, and combinations thereof.

39. The method according to claim 37, wherein at least one of said first material and said second material is an oxide of a lanthanum group metal.

40. The method according to claim 37, wherein said first cation and said second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron.

41. The method according to claim 37, wherein said major phase of said ceramic material is one of an oxide, a boride, a carbide, a nitride, an oxynitride, and combinations thereof.

42. The method according to claim 37, wherein said major phase of said ceramic material is one of YAG, YAG:Nd, YAG, YAG:Yb and YbAG.

43. The method according to claim 37, wherein said major phase of said ceramic material has a density in a range from about 98 percent to 100 percent of a theoretical density of said major phase.

44. The method according to claim 37, wherein said solvent is an aqueous solvent.

45. The method according to claim 37, wherein said solvent is a nonaqueous solvent.

46. The method according to claim 45, wherein said nonaqueous solvent is a polar solvent.

47. The method according to claim 46, wherein said polar solvent is an alcohol.

48. The method according to claim 45, wherein said nonaqueous solvent is a nonpolar solvent.

49. The method according to claim 48, wherein said nonpolar solvent is one of an alkane, an alkene, and combinations thereof.

50. The method according to claim 48, wherein said nonpolar solvent is one of hexane, toluene, carbon tetrachloride, and combinations thereof.

51. The method according to claim 37, wherein the step of drying said mixture to form a dried mixture comprises at least one of temperature-assisted drying said mixture, spray drying said mixture, freeze drying said mixture, reduced pressure drying said mixture, and combinations thereof.

52. The method according to claim 37, wherein the step of forming a green body from said powder comprises one of compacting said mixture under uniaxial pressure, compacting said mixture under biaxial pressure, compacting said mixture under isostatic pressure, extruding said mixture, injection molding said mixture, slip casting said mixture, and gel casting said mixture.

53. The method according to claim 37, wherein the step of sintering said green body comprises sintering said green body at a temperature in a range from about 1000° C. to about 2100° C. for a predetermined time.

54. The method according to claim 53, wherein said predetermined time is in a range from about 0.5 hour to about 24 hours.

55. The method according to claim 37, wherein the step of providing at least a first material and a second material further comprises providing at least one additional material, wherein said at least one additional material comprises at least one cation that is different from said first cation and said second cation, and wherein said at least one additional material is a nanopowder.

56. A method of making an article comprising a multi-cation ceramic material, the method comprising the steps of:
a) providing at least a first material and a second material, wherein said first material comprises a first cation and said second material comprises a second cation, said first cation and said second cation being different from each other, and wherein each of said first material and said second material are nanopowders;
b) forming a slurry comprising said first material, said second material, at least one dispersant, and a solvent;
c) mixing said slurry to form a mixture comprising said first material and said second material;
d) drying said slurry to form a powder;
e) forming a green body from said powder;
f) sintering said green body at a controlled pressure to form a sintered body; and
g) finishing said sintered body to form said article, wherein said article comprises a major phase comprising said first cation and said second cation, wherein said major phase is different from said first material and said second material, has an average grain size of less than 1 micron, and is transparent, and wherein said article has a specular transmission of at least 50% normalized to a 1 mm thick specimen.

57. The method according to claim 56, wherein said article has a specular transmission of at least 65%.

58. The method according to claim 56, wherein said article is transparent to infrared radiation.

59. The method according to claim 56, wherein said article is transparent to ultraviolet radiation.

60. The method according to claim 56, wherein said article is transparent to visible light.

61. The method according to claim 56, wherein each of said first material and said second material is one of a fluoride, an oxide, a nitride, a carbide, a chalcogenide and combinations thereof.

62. The method according to claim 56, wherein at least one of first material and said second material is an oxide of a lanthanum group metal.

63. The method according to claim 56, wherein said first cation and said second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron.

64. The method according to claim 56, wherein said major phase of said ceramic material is one of an oxide, a boride, a carbide, a nitride, an oxynitride, and combinations thereof.

65. The method according to claim 56, wherein said major phase of said ceramic material is one of YAG, YAG:Nd, YAG, YAG:Yb and YbAG.

66. The method according to claim 56, wherein said major phase of said ceramic material has a density in a range from about 98 percent to 100 percent of a theoretical density of said major phase.

67. The method according to claim 56, wherein said solvent is an aqueous solvent.

68. The method according to claim 56, wherein said solvent is a nonaqueous solvent.

69. The method according to claim 68, wherein said nonaqueous solvent is a polar solvent.

70. The method according to claim 69, wherein said polar solvent is an alcohol.

71. The method according to claim 68, wherein said nonaqueous solvent is a nonpolar solvent.

72. The method according to claim 71, wherein said nonpolar solvent is one of an alkane, an alkene, and combinations thereof.

73. The method according to claim 71, wherein said nonpolar solvent is one of hexane, toluene, carbon tetrachloride, and combinations thereof.

74. The method according to claim 56, wherein the step of drying said mixture to form a dried mixture comprises at least one of temperature-assisted drying said mixture, spray drying said mixture, freeze drying said mixture, reduced pressure drying said mixture, and combinations thereof.

75. The method according to claim 56, wherein the step of forming a green body from said powder comprises one of compacting said mixture under uniaxial pressure, compacting said mixture under biaxial pressure, compacting said mixture under isostatic pressure, extruding said mixture, injection molding said mixture, slip casting said mixture, and gel casting said mixture.

76. The method according to claim 56, wherein the step of sintering said green body comprises sintering said green body at a temperature in a range from about 1000° C. to about 2100° C. for a predetermined time.

77. The method according to claim 76, wherein said predetermined time is in a range from about 0.5 hour to about 24 hours.

78. The method according to claim 56, wherein the step of providing at least a first material and a second material further comprises providing at least one additional material, wherein said at least one additional material comprises at least one cation that is different from said first cation and said second cation, and wherein said at least one additional material is a nanopowder.

79. A ceramic material, said ceramic material comprising a major phase, said major phase comprising at least a first cation and a second cation, wherein said first cation and said second cation are different from each other, and having an average grain size of less than 1 micron, wherein said ceramic material is transparent and has a specular transmission of at least 50%, normalized to a 1 mm thick specimen.

80. The ceramic material according to claim 79, wherein said ceramic material is transparent to infrared radiation.

81. The ceramic material according to claim 79, wherein said ceramic material is transparent to ultraviolet radiation.

82. The ceramic material according to claim 79, wherein said ceramic material is transparent to visible light.

83. The ceramic material according to claim 79, wherein a 1 mm thick specimen of said ceramic material has a specular transmission of at least 65%.

84. The ceramic material according to claim 79, wherein said first cation and said second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron.

85. The ceramic material according to claim 79, wherein said major phase of said ceramic material is one of an oxide, a boride, a carbide, a nitride, an oxynitride, and combinations thereof.

86. The ceramic material according to claim 79, wherein said major phase of said ceramic material is one of YAG, YAG:Nd, YAG, YAG:Yb and YbAG.

87. The ceramic material according to claim 79, wherein said major phase of said ceramic material has a density in a range from about 98 percent to 100 percent of a theoretical density of said major phase.

88. The ceramic material according to claim 79, wherein said ceramic material forms at least a portion of a filter, a scintillator, a window, and a transparent armor article.

89. A ceramic article, said ceramic article comprising a major phase, said major phase comprising at least a first cation and a second cation, wherein said first cation and said second cation are different from each other, and having an average grain size of less than 1 micron, wherein said ceramic article is formed by:
a) providing at least a first material and a second material, wherein said first material comprises a first cation and said second material comprises a second cation, said first cation and said second cation being different from each other and wherein each of said at least first material and said second material are nanopowders;
b) forming a slurry comprising said at least first material, said second material, at least one dispersant, and a solvent;
c) mixing said slurry to form a mixture comprising said at least first material and said second material;
d) drying said slurry to form a powder;
e) forming a green body from said powder;
f) sintering said green body at ambient pressure to form a sintered body; and
g) finishing said sintered body to form said ceramic article.

90. The ceramic article according to claim 89, wherein said major phase comprising the first cation and the second cation is different from said first material and said second material.

91. The ceramic article according to claim 89, wherein said ceramic article is transparent.

92. The ceramic article according to claim 89, wherein said ceramic article is transparent to infrared radiation.

93. The ceramic article according to claim 89, wherein said ceramic article is transparent to ultraviolet radiation.

94. The ceramic article according to claim 89, wherein said ceramic article is transparent to visible light.

95. The ceramic article according to claim 89, wherein a 1 mm thick specimen of ceramic material has a specular transmission of at least 50%.

96. The ceramic article according to claim 89, wherein said 1 mm thick specimen of ceramic material has a specular transmission of at least 65%.

97. The ceramic article according to claim 89, wherein said first cation and said second cation are selected from the group consisting of cations of yttrium, ytterbium, lutetium, cerium, erbium, thulium, praseodymium, gadolinium, lanthanum, neodymium, holmium, aluminum, gallium, calcium, magnesium, scandium, zirconium, and iron.

98. The ceramic article according to claim 89, wherein said major phase of said ceramic material is one of an oxide, a boride, a carbide, a nitride, an oxynitride, and combinations thereof.

99. The ceramic article according to claim 89, wherein said major phase of said ceramic material is one of YAG, YAG:Nd, YAG, YAG:Yb and YbAG.

100. The ceramic article according to claim 89, wherein said major phase of said ceramic material has a density in a range from about 98 percent to 100 percent of a theoretical density of said major phase.

101. The ceramic article according to claim 89, wherein said ceramic material forms at least a portion of a filter, a scintillator, a window, and a transparent armor.

102. The ceramic article according to claim 89, wherein the step of providing at least a first material and a second material further comprises providing at least one additional material, wherein said at least one additional material comprises at least one cation that is different from said first cation and said second cation, and wherein said at least one additional material is a nanopowder.
